(19) United States
(12) Patent Application Publication
(10) Pub. No.: US 2008/0288346 A1
(43) Pub. Date: Nov. 20, 2008

(54) Method for Private Sellers to Certify Previously Owned Vehicles

(76) Inventor: Howard Morris Shames, Pennfield, NY (US)

Correspondence Address: DELAIN LAW OFFICE, PLLC, 107 NORTH COLLEGE ST., SCHENECTADY, NY, 12305, US

(21) Appl. No.: 11/749,948

(22) Filed: May 17, 2007

(51) Int. Cl. G06Q 30/00

(52) U.S. Cl. 705/14; 705/1

(57) ABSTRACT

A method is taught whereby an individual vehicle seller who wishes to sell his or her vehicle privately (without using a dealer) can provide a potential purchaser with a certification of the vehicle that is backed by a known and reputable vehicle maintenance-and-repair entity. A method of advertising the certification online is also provided as an optional marketing outlet to the vehicle seller.

### BACKGROUND OF THE INVENTION

1. Field of the Invention

The field of the invention is methods of marketing, specifically the marketing of previously owned vehicles.

2. Description of Related Art

U.S. Pat. No. 5,915,019 teaches systems and methods for secure transaction management and electronic rights protection. Electronic appliances such as computers equipped in accordance with the present invention help to ensure that information is accessed and used only in authorized ways, and maintain the integrity, availability, and/or confidentiality of the information. Such electronic appliances provide a distributed virtual distribution environment (VDE) that may enforce a secure chain of handling and control, for example, to control and/or meter or otherwise monitor use of electronically stored or disseminated information. Such a virtual distribution environment may be used to protect rights of various participants in electronic commerce and other electronic or electronic-facilitated transactions. Distributed and other operating systems, environments and architectures, such as, for example, those using tamper-resistant hardware-based processors, may establish security at each node. These techniques may be used to support an all-electronic information distribution, for example, utilizing the “electronic highway.”

U.S. Pat. No. 6,622,129 teaches a method of creating an index of residual values for leased assets such as vehicles, transferring residual value risk, and creating lease securitizations. The index of residual values includes valuation information pertaining to different types of vehicles, different models and submodels of vehicles, different combinations of vehicle options, different vehicle model years, etc. The residual value index is updated with subsequent valuations of the leased assets and is employed to facilitate the transfer of residual value risk and create lease securitizations via mechanisms such as residual value futures, options, bonds and insurance products.

U.S. Pat. No. 7,131,005 teaches a component for use in a prospective vehicle obtains from a certification authority a certification that an authentic vehicle is associated with a cryptographic key. The certification certifies that the cryptographic key is bound to information identifying the authentic vehicle. The component utilizes the cryptographic key obtained from the certification authority in cryptographic communication with the prospective vehicle, and determines whether the prospective vehicle is the authentic vehicle based on whether the cryptographic key is successfully utilized in the cryptographic communication. Upon determining the prospective vehicle is the authentic vehicle, the component may allow the prospective vehicle to operate the component.

US Patent Application No. 20010027432 teaches a method of establishing a system of a secondary market for disbursement information, wherein with “purchase plan information” of merchandise owned by a nation or others added with an asset value and utilized independently, purchase plan information is given to business firms that desire to utilize it, its cost being payable by potential purchasers, as the information has an asset value. Each disbursement information can be called as information of planned purchase or “Purchase Plan Information”. Said purchase plan information is quantified; its value is computed, swapped to bonds or warrants, or swapped to securities by fixing a common currency unit like yen; said information is sold, bought or brokered at a secondary market for information; said information is brokered at auction under appropriate conditions of the auction to facilitate its distribution; and the value of said information is increased by using said information for operation in said market for better returns.

US Patent Application No. 20030055667 teaches supplying manufactured product or service information to a central databas. Each product or service carries a unique identifier and customers can read the identifier and access the information held on the database. Preferably the information is certified by a keeper of the database.

US Patent Application No. 20060206248 teaches a method of calculating a service policy for a vehicle. The method comprises determining a number of miles driven by the vehicle and the condition of the vehicle. Furthermore, a mileage range for the vehicle is determined. The cost of the service police is calculated by a computer in response to the condition of the vehicle, the number of miles driven by the vehicle and the mileage range.

Canadian Patent No. 2380523 teaches a vehicle resale price analysis system comprising a first step of extracting data relating to resold vehicles resold during a specified period, a second step of extracting by correlation analysis causes affecting vehicle resale prices by using data extracted in the first step, and a third step of obtaining a multiple regression expression from a correlation between the extracted causes and data on resold amounts, wherein the multiple regression expression obtained in the third step is used for predicting information on pre-reselling estimated selling amounts, estimated residual values or estimated residual ratios of vehicles to enable the objective estimation of selling amounts of articles before reselling based on selling data on resold articles such as vehicles and without depending on human experiences.

European Patent Office Patent No. JP2002163498 teaches a car type database obtained by relating the kind of a car with data written on a vehicle examination certificate, a market price database obtained by relating the kind of the used car with a contract price at the market of the used car, a scanner for reading the image of the vehicle examination certificate of a car to be inspected, a data recognition means for obtaining data written in the vehicle examination certificate from the image of the vehicle examination certificate, a means for specifying the car to be inspected which specifies the kind of the car to be assessed from the data by referring to the database 30, a market price obtaining means for obtaining the contract price of the specified kind of the car to be assessed from the database 31 and an assessing means for assessing the buying price of the car to be assessed based on this contract price.

European Patent Office Patent No. JP2004070520 teaches a certification method for a car maintenance record or its system comprising a first input means accepts an input of key data enabling specifying of certification target, the first input means or another second input means accepts an input of maintenance contents specifying data on a car of the certification target, and a storage mans stores the key data and the specifying data. Furthermore, an extracting means extracts the specifying data of the certification target among the data stored into the storage means, according to the key data, and a certification data output means outputs certification data according to the extracted specifying data.

A search of the internet shows that certification programs for previously owned vehicles exist. However, all programs found are based either in the manufacturer's warranty program or in the dealer's guarantee program.

A need is felt in the art for a method whereby an individual vehicle seller who wishes to sell his or her vehicle without using a dealer can provide a potential purchaser with a certification of the vehicle that is backed by a known and reputable vehicle maintenance-and-repair entity.

### BRIEF SUMMARY OF THE INVENTION

A method is taught whereby an individual or a business vehicle seller who wishes to sell his or her vehicle without using a dealer can provide a potential purchaser with a certification of the vehicle that is backed by a known and reputable vehicle maintenance-and-repair entity, thus providing the potential purchaser with similar peace of mind to that which the purchaser enjoys when purchasing a car from a dealer using a certified used-car program. An associated Virtual Showroom website is provided whereby the seller may market the vehicle with full disclosure of the results of the certification process. In another embodiment, other services may also be offered through the Virtual Showroom website, such as value-added services seen on reputable car dealers' websites, such as obtaining a loan, obtaining insurance, obtaining extended warranties, cross-linking to other websites, logging callback requests, and other value-added services. The Virtual Showroom also serves to provide a way for the consumer to verify the certification of the vehicle they are considering purchasing. This verification can be provided through many possible methods, including but not limited to the website itself, the telephone, certification documentation, a communication means with the certifying entity, and other possible methods. In another embodiment, a Repair Vendor contacts a retail establishment selling its own used vehicles, and offers to certify all or any part of their inventory. The retail establishment selling the used vehicles may utilize the Virtual Showroom if it so chooses.

### BRIEF DESCRIPTION OF THE DRAWINGS

FIG. 1 shows an overview of a method of vehicle sale by a private seller.

FIG. 2 shows a process whereby a vehicle that does not pass a vehicle examination is repaired or not within the overall process.

FIG. 3 shows details of the vehicle examination certificate contents.

FIG. 4 shows an overview of an advertising process that the seller may follow.

FIG. 5 shows details of the contents of an online Virtual Showroom advertising method that is optionally available to the seller.

FIG. 6 shows an overview of a secure system behind the online Virtual Showroom.

FIG. 7 shows an overview of system administration functions that are available to system administrators (not to a general user) of the online Virtual Showroom.

### DETAILED DESCRIPTION OF THE INVENTION

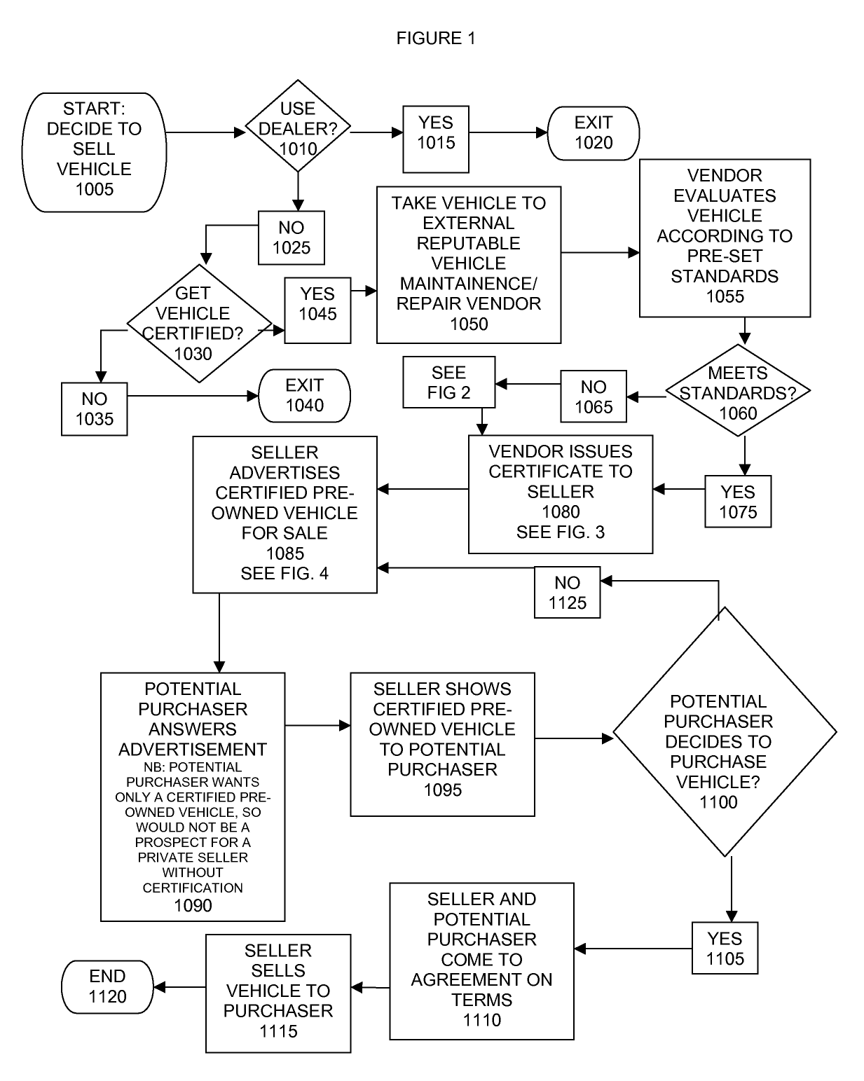

Referring now to FIG. 1, an overview of a method of vehicle sale by a seller not associated with an auto dealership is shown. The seller may be either an individual or a business. The seller decides to sell a vehicle 1005. The seller has a choice 1010 as to whether or not to use a dealer. If he decides to use a dealer 1015, he need not use the method taught herein and exits 1020 the method.

If the seller decides to sell the vehicle without using a dealer 1025, he must then decide 1030 whether or not to get the vehicle certified. If the seller decides not to get the vehicle certified 1035, he exits this method 1040.

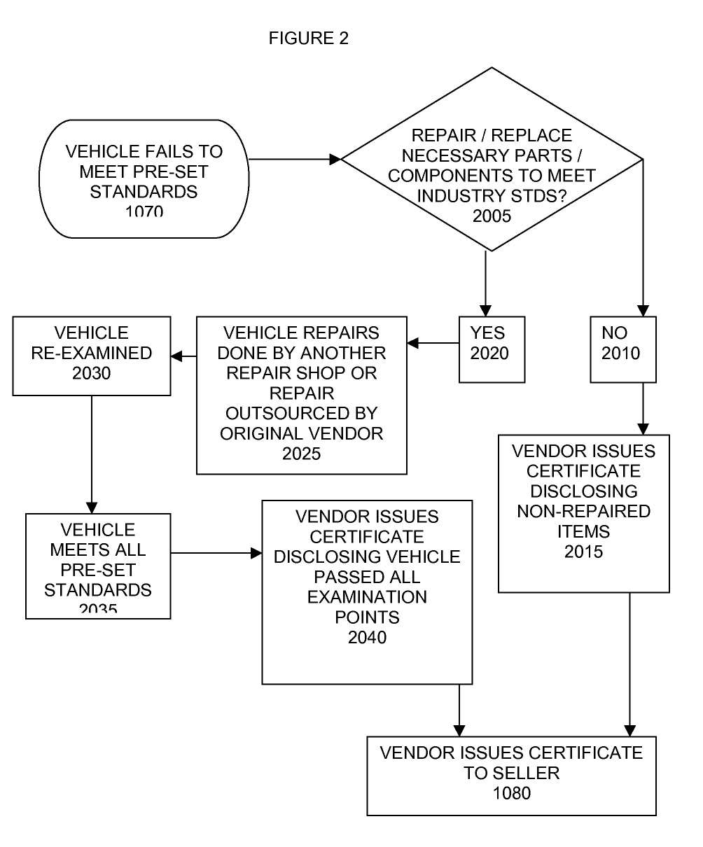

If the seller decides to have the vehicle certified 1045, she utilizes an external commercially well-known vehicle maintenance-and-repair vendor to perform an evaluation of the condition of the vehicle 1050. The vendor evaluates the vehicle against pre-set vehicle industry standards 1055. The list of standards 1055 against which the vehicle is examined is listed in Table 1. The vehicle encounters a choice point 1060 in the method. If the vehicle does not meet the pre-set standards 1065, the vehicle begins the evaluation process as a vehicle that does not meet pre-set standards 1070. This can be overcome; the method for certifying the vehicle despite the vehicle not meeting pre-set standards is described in FIG. 2.

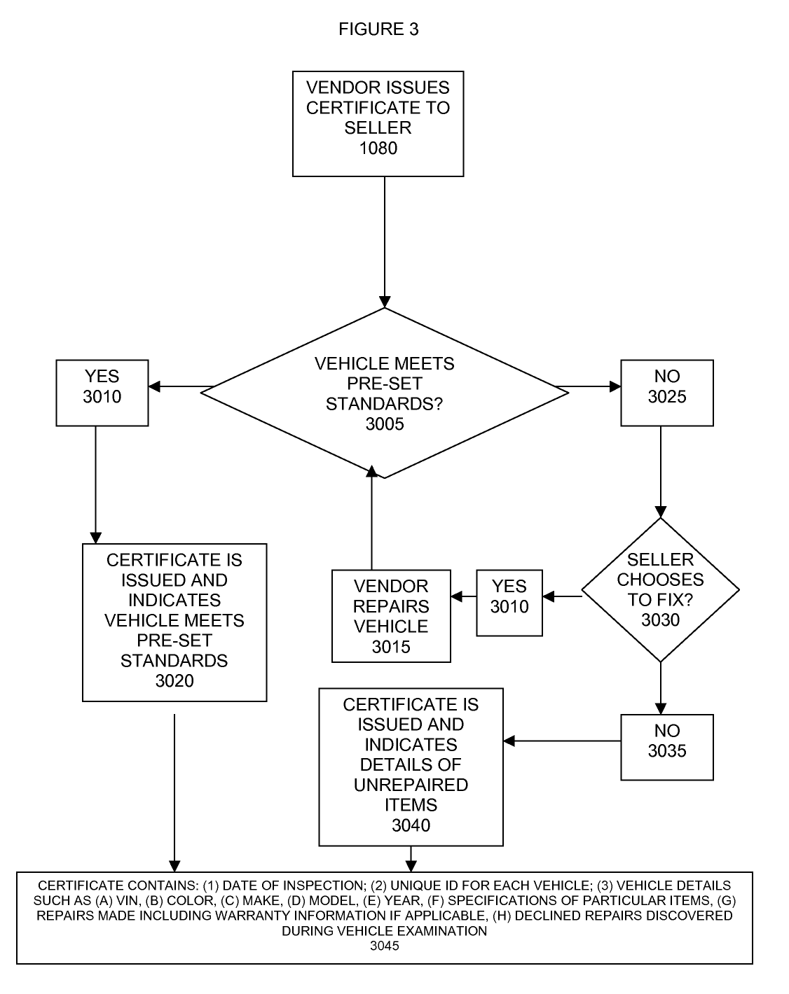

If the vehicle meets pre-set standards 1075, the vendor issues a certificate 1080. The certificate verifies that the vehicle underwent a valid inspection process to determine the present state of the vehicle and declares that the vehicle was inspected by a qualified mechanic who determined that the examined parts and or components of the vehicle did or did not meet predetermined industry standards at the time of the evaluation. This process is further discussed under FIG. 3.

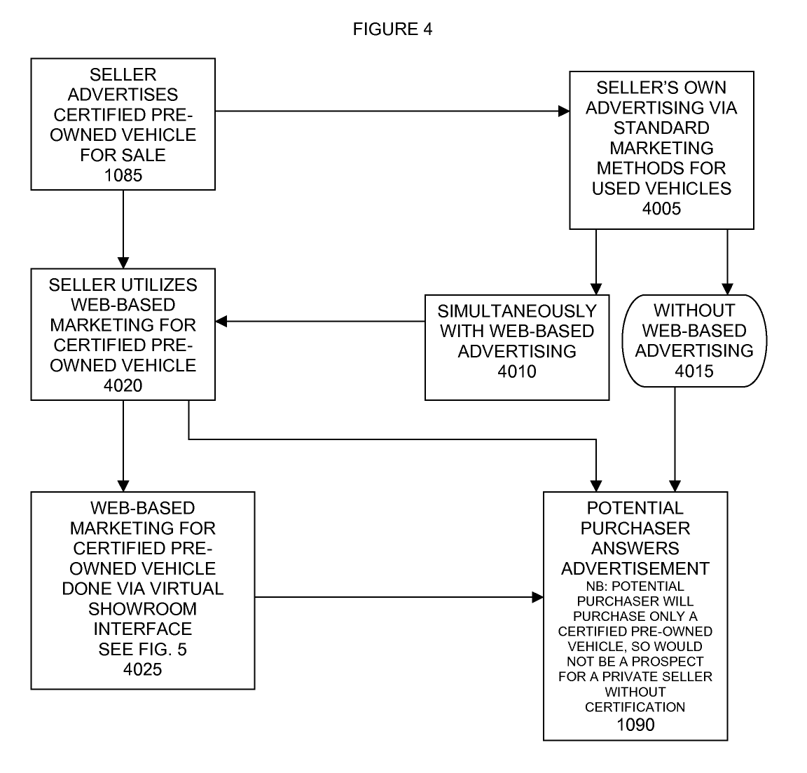

The seller then advertises the vehicle for sale as a certified pre-owned vehicle 1085. This process is further discussed under FIG. 4.

A potential purchaser who is in the market only for a certified pre-owned vehicle responds to the private seller's advertisement 1090. Thus, by using the private certification process, the private seller has acquired a potential customer who may not have considered purchasing the seller's uncertified vehicle.

The seller shows the certified pre-owned vehicle to the potential purchaser 1095. The potential purchaser then decides whether or not to purchase the vehicle 1100. If the potential purchaser decides to purchase the vehicle 1105, the seller and potential purchaser agree on the terms of the sale 1110, the seller sells the certified vehicle to the potential purchaser 1115 and the method ends 1120. If the potential purchaser decides not to purchase the vehicle 1125, the seller repeats the process of advertising the certified pre-owned vehicle 1085 and showing the vehicle to another potential purchaser 1090 et seq. until the vehicle is sold.

The vehicle may be an automobile, a sport utility vehicle, a pickup truck, a van, a tractor, a lawn mower, a recreational vehicle such as a mobile home or camper, a heavy truck, a bus, a boat, a motorized water-ski recreational vehicle, a yacht, a snowmobile, a motorcycle, and a motorized bicycle. This listing is, however, merely intended as examples and should not be interpreted to exclude other vehicles not listed here.

In another embodiment, this method may be used to certify any used merchandise, such as computers, printers,

TABLE 1
Vehicle Pre-Set Standards Examination Checklist
INSPECTION CHECKLIST

| | |
|---|---|
| PART 1 | Vehicle & Customer Information |

| | | |
|---|---|---|
| Date: | Vin # | Mileage: |

| | | |
|---|---|---|
| Make: | Model: | Year: |

Customer Name:

| | | | |
|---|---|---|---|
| Address: | City: | State: | Zip: |

DEFINITIONS:
***** = Above Aver *** = Average * = Below Aver N/A =Not Applicable
PASS = Is in working order and/ or is acceptable
FAIL = Is not in working order and/ or is not in need of repair

| | |
|---|---|
| PART II | Mechanical |

| | | | | |
|---|---|---|---|---|
| | PASS | FAIL | N/A | Comments |
| Headlight assembly | □ | □ | □ | |
| Fog Lamp Assembly | □ | □ | □ | |
| Headlight washer assembly | □ | □ | □ | |
| Wiper blade, assembly & jets | □ | □ | □ | |
| Door handle, hinge & lock | □ | □ | □ | |
| Central locking functions | □ | □ | □ | |
| Alarm functions | □ | □ | □ | |
| Seat % headrest functions | □ | □ | □ | |
| Seatbelt(s) | □ | □ | □ | |
| Airbag(s) | □ | □ | □ | |
| Child locking functions | □ | □ | □ | |
| Fuel-filler door looking | □ | □ | □ | |
| Trunck lock | □ | □ | □ | |
| Rear wiper | □ | □ | □ | |
| Shocks | □ | □ | □ | |
| Suspension Components | □ | □ | □ | |
| Front control arm bushings | □ | □ | □ | |
| Steering | □ | □ | □ | |
| Major component mounts | □ | □ | □ | |
| Exhaust system | □ | □ | □ | |
| Belts | □ | □ | □ | |
| Belt tensioners | □ | □ | □ | |
| Fluid Levels: | | | | |
| Oil | □ | □ | □ | |
| Brake | □ | □ | □ | |
| Power Stearing | □ | □ | □ | |
| Washer | □ | □ | □ | |
| Transmission | □ | □ | □ | |
| Rear Axle | □ | □ | □ | |

| | | | | | | | |
|---|---|---|---|---|---|---|---|
| Coolant: Protection Level (Circle one) | −5 F. | −10 F. | −15 F. | −20 F. | −25 F. | −30 F. | −35 F. |

| | | |
|---|---|---|
| Service | Acceptable | Good |

Fluid Leaks (of components, tanks & counting)

| | | | |
|---|---|---|---|
| Transmission | □ | □ | □ |
| Transfer Case | □ | □ | □ |
| Differential (Front/Rear) | □ | □ | □ |
| Half Shafts (Front/Rear) | □ | □ | □ |
| Gas | □ | □ | □ |
| Brake | □ | □ | □ |
| Power Steering | □ | □ | □ |
| Shocks & Struts | □ | □ | □ |
| Self-leveling | □ | □ | □ |
| Coolant | □ | □ | □ |
| Hydraulic | □ | □ | □ |

| | | | | | | |
|---|---|---|---|---|---|---|
| Battery Voltage: (Circle one) | 11.3 | 12.0 | 12.3 | 12.4 | 12.5 | 12.1 |

| | | |
|---|---|---|
| REPLACE | CHARGE | GOOD |

| | |
|---|---|
| PART III | Body Condition, Fit & Finish |

| | | | | | |
|---|---|---|---|---|---|
| AREA INSPECTED | ***** | *** | * | N/A | Comments |
| Front Bumper | □ | □ | □ | □ | |
| Hood | □ | □ | □ | □ | |
| Core support | □ | □ | □ | □ | |
| Engine carryong rails | □ | □ | □ | □ | |
| Inner fenders | □ | □ | □ | □ | |
| Front Fenders: left & right | □ | □ | □ | □ | |
| A pilar: left & right | □ | □ | □ | □ | |
| B pilar: left & right | □ | □ | □ | □ | |
| C pilar: left & right | □ | □ | □ | □ | |
| D pilar: left & right | □ | □ | □ | □ | |
| Rocker/bill panets | □ | □ | □ | □ | |
| Roof | □ | □ | □ | □ | |
| Convertible Top | □ | □ | □ | □ | |
| Sunroof | □ | □ | □ | □ | |
| Quater panel: left & right | □ | □ | □ | □ | |
| Antenna | □ | □ | □ | □ | |
| Trunk lid | □ | □ | □ | □ | |
| Hatch (model dependent) | □ | □ | □ | □ | |
| Tailgate (model dependent) | □ | □ | □ | □ | |
| Rear license plate | □ | □ | □ | □ | |
| Rear tailight assemblies | □ | □ | □ | □ | |
| Rear bumper | □ | □ | □ | □ | |
| Spare wheel well | □ | □ | □ | □ | |
| Rear floor pan | □ | □ | □ | □ | |
| Inner trunk panels | □ | □ | □ | □ | |
| Fuel-filler door | □ | □ | □ | □ | |
| Mirror assemblies (2) | □ | □ | □ | □ | |
| Alignment of all panels | □ | □ | □ | □ | |
| GLASS AREA | | | | | |
| Windshield | □ | □ | □ | □ | |
| VIN ID | □ | □ | □ | □ | |
| Door & side glass | □ | □ | □ | □ | |
| Rear window | □ | □ | □ | □ | |
| Exterior mirror | □ | □ | □ | □ | |
| Interior mirrors | □ | □ | □ | □ | |
| INTERIOR AREA | | | | | |
| Door weather seal | □ | □ | □ | □ | |
| Carpet/floormat | □ | □ | □ | □ | |
| Wood trim | □ | □ | □ | □ | |
| Cupholder(s) | □ | □ | □ | □ | |
| Interior light(s) | □ | □ | □ | □ | |
| Glove Box | □ | □ | □ | □ | |
| Seat | □ | □ | □ | □ | |
| Headiner | □ | □ | □ | □ | |
| KEYS | | | | | |

| | | |
|---|---|---|
| Master(s) | □ | □ |

| | |
|---|---|
| Valet | □ |
| Wallet | □ |

| | |
|---|---|
| PART IV | WHEEL ASSEMBLY |

TIRE INSPECTION
TIRE TREAD DEPTH (minimum 3 mm [ 4/32 in. when measured from the TOP of wear indicators) & SIDE
WALL INSPECTION

| | | | | |
|---|---|---|---|---|
| Location | Inside | Center | Outside | Suel Brand & Condition |

| | | | |
|---|---|---|---|
| Left Front | mm | mm | mm |
| Left Rear | mm | mm | mm |
| Spare | mm | mm | mm |
| Right Rear | mm | mm | mm |
| Right | mm | mm | mm |
| Front | | | |
| Wheels | ***** | *** | * |
| Left Front | □ | □ | □ |
| Left Rear | □ | □ | □ |
| Spare | □ | □ | □ |
| Right Rear | □ | □ | □ |
| Right | □ | □ | □ |
| Front | | | |

| | |
|---|---|
| INSPECTION OF TIRE PRESSURE: | □ |

BRAKE INSPECTION
BRAKE PADS (minimum 5 mm) & Disc Inspection

| | | | |
|---|---|---|---|
| Location | Pad Measurement | Disc Condition | Comments |

| | |
|---|---|
| Left Front | mm |
| Left Rear | mm |
| Right Rear | mm |
| Right Front | mm |

| PART V | STATIONARY REVIW | | | |
|---|---|---|---|---|
| | PASS | FAIL | N/A | Comments |
| AREA | | | | |
| Driver's Seat Functions | | | | |
| Belt | □ | □ | □ | |
| Front/Back-up/down | □ | □ | □ | |
| Headrest | □ | □ | □ | |
| Lumbar | □ | □ | □ | |
| Mirror Functions | | | | |
| Outside left/Right | □ | □ | □ | |
| Interior | □ | □ | □ | |
| Navigation System | | | | |
| Functional Test | □ | □ | □ | |
| On-Board Computer System | | | | |
| Functional Test | □ | □ | □ | |
| Steering Wheel | | | | |
| Adjustable | □ | □ | □ | |
| Airbag | □ | □ | □ | |
| Audio Functions | □ | □ | □ | |
| Horn Functions | □ | □ | □ | |
| Stalk controls: | | | | |
| Wiper/washer | □ | □ | □ | |
| High Beams | □ | □ | □ | |
| Computor | □ | □ | □ | |
| Pedal Function | | | | |
| Gas | □ | □ | □ | |
| Brake | □ | □ | □ | |
| Clutch | □ | □ | □ | |
| Gear Shift Function | □ | □ | □ | |
| Parking Brake Function | □ | □ | □ | |
| HVAC Control: | | | | |

| | | | | | | | |
|---|---|---|---|---|---|---|---|
| Heat (circle one) | 50 F. | 55 F. | 60 F. | 65 F. | 70 F. | 75 F. | 85 F. |

| | | |
|---|---|---|
| Servers | Acceptable | Good |

| | | | | | | | |
|---|---|---|---|---|---|---|---|
| A/C (circle one) | 40 F. | 45 F. | 50 F. | 55 F. | 60 F. | 65 F. | 70 F. |

| | | |
|---|---|---|
| Good | Acceptable | Service |

| | | | |
|---|---|---|---|
| Fan | □ | □ | □ |
| Temp Range | □ | □ | □ |
| Blower Speed | □ | □ | □ |
| Blower: | □ | □ | □ |
| Defrost | □ | □ | □ |
| Center | □ | □ | □ |
| Lower | □ | □ | □ |
| Vent Controls | □ | □ | □ |
| Windshield Defogger | □ | □ | □ |
| Rear Window Defrost | □ | □ | □ |
| Re-circulating | □ | □ | □ |
| Audits Function | | | |
| Radio: AM | □ | □ | □ |
| FM | □ | □ | □ |
| Cassette | □ | □ | □ |
| CD | □ | □ | □ |
| Speakers: Balance | □ | □ | □ |
| Fads | □ | □ | □ |
| Electrical | | | |
| Vanity/Visor | □ | □ | □ |
| Map Interior | □ | □ | □ |
| Headlights | □ | □ | □ |
| Fog Lights | □ | □ | □ |
| Turn Signals | □ | □ | □ |
| Hazard flasher | □ | □ | □ |
| Parking/Side Marker | □ | □ | □ |
| Brake Lights (3) | □ | □ | □ |
| Back-up Lights | □ | □ | □ |
| Plate lights | □ | □ | □ |
| Dash & Console | □ | □ | □ |
| Door look | □ | □ | □ |
| Seat Heaters | □ | □ | □ |
| Power Windows | □ | □ | □ |
| Cigarette lighter | □ | □ | □ |
| Power Sunroof | □ | □ | □ |

| | |
|---|---|
| PART VI | ROLLING EVALUATION |

Checklist to be complete after the test drive for safety
Engine Performance

| | | | |
|---|---|---|---|
| Cold/HotStarting | □ | □ | □ |
| Idle Smoothness | □ | □ | □ |
| Acceleration | □ | □ | □ |
| Transmission Shifting | | | |
| Manual/Auto | □ | □ | □ |
| Cruise Control | | | |
| Functions | □ | □ | □ |
| Noise | | | |
| Wind | □ | □ | □ |
| Squeaks | □ | □ | □ |
| Rattlers | □ | □ | □ |
| Vehicle Handling | | | |
| Vibration | □ | □ | □ |
| Stability | □ | □ | □ |
| Braking | □ | □ | □ |
| ABS | □ | □ | □ |
| ASC/DSC | □ | □ | □ |
| Steering Wheel | | | |
| Alignment | □ | □ | □ |
| Instrument Gauges | | | |
| operational | □ | □ | □ |
| Other: | □ | □ | □ |
| | □ | □ | □ |

Additional Comments by Technician (Optional)

| | |
|---|---|
| Technician's Name: | Signature |
| Service Mgr's Name: | Signature |

Referring now to FIG. 2, a process is shown whereby a vehicle that does not meet pre-set standards is certified in the process discussed under FIG. 1.

A vehicle that does not meet pre-set standards 1070 presents its seller with a choice of whether to repair and/or replace the components necessary to meet the industry standards against which the vehicle was inspected 2005.

Should the seller decide not to repair the vehicle 2010, the certificate shows all non-repaired items that caused the vehicle to fail to meet pre-set standards 2015. The vendor issues the certificate to the seller 1080.

Should the seller decide to repair the vehicle 2020, the repair is done 2025. If the repair is done by another vendor or if the inspecting vendor outsources vehicle repairs 2025, the vehicle is re-examined by the original inspecting vendor or by another vendor who also issues certificates for pre-owned vehicles 2030 and, if it meets the required pre-set standards 2035, a certificate is issued showing that the vehicle passed all examination points 2040. The vendor issues the certificate in both cases to the seller 1080.

In an alternate embodiment, the seller may have the vehicle repair done and a receipt or other proof of repair provided by the repairing vendor serves as proof that the vehicle now meets the repaired pre-set standards without a re-examination of the vehicle.

Referring now to FIG. 3, details of the examination certificate contents are shown.

The certificate provided to the seller by the vendor differentiates 3005 between vehicles that meet pre-set standards 3010 and those that do not meet pre-set standards 3025.

If the vehicle meets pre-set standards 3010, a certificate is issued that indicates the vehicle meets said pre-set standards 3015.

If the vehicle does not meet pre-set standards 3025, the seller is again faced with the choice of whether or not to repair the vehicle 2005. Should he choose not to repair 3030, the issued certificate indicates all details of unrepaired items 3035. Should she choose to repair 2020, the repair and re-examination process detailed in FIG. 2 is performed 3020 and, when the vehicle meets all pre-set standards, the vendor issues a certificate indicating that the vehicle has met pre-set standards 3015.

The certificate in both cases contains information 3040 regarding: the date of vehicle examination; a vendor-issued unique identifier for each vehicle inspected by the vendor; vehicle details such as: VIN, color, make, model, year, specifications of particular items (such as parts information), repair information, including warranty information, if applicable; and any repairs needed that were discovered in the vehicle examination and repair declined by the seller.

Referring now to FIG. 4, a detailed overview of the advertising process that the seller may follow in marketing and selling the vehicle 1085 is shown.

The seller may choose to utilize an optional, proprietary Virtual Showroom provided to sellers of vehicles certified as shown in FIG. 1. The Virtual Showroom is an internet website that allows the private seller and potential purchaser to access all tools that are generally available through a related commercial sales entity such as a vehicle dealer's website and/or showroom.

The seller may herself advertise using marketing methods that are not associated with the Virtual Showroom service 4005. These methods may include, but are not limited to, any or all of the following: classified or display newspaper advertisements, publications such as a classified advertising digest that list items for sale, a for-sale sign in the window of the vehicle.

The seller may choose to market the vehicle using print and web-based advertising simultaneously 4010.

The seller may choose to market the vehicle without web-based advertising 4015. A potential purchaser would thus answer a print advertisement 1090.

The seller may choose to list the vehicle with any vehicle sales internet sites that are not affiliated with the method herein described 4020.

The seller may choose to market his vehicle through the Virtual Showroom service 4025. He may use the Virtual Showroom exclusively, or he may use the Virtual Showroom in combination with standard marketing methods 4025.

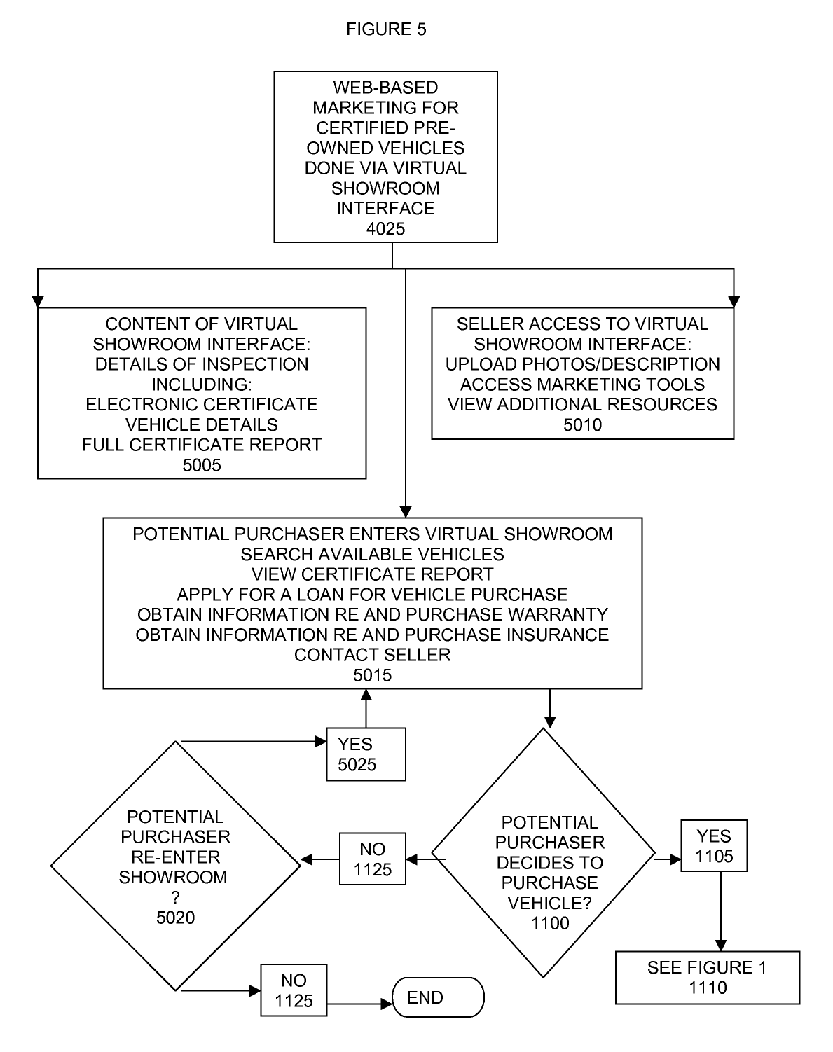

Referring now to FIG. 5, details of the contents of an optional online Virtual Showroom advertising method that is available to the seller are shown.

The Virtual Showroom contains 5005 details of the vehicle examination by the vendor, including an electronic version of the certificate, details about the vehicle, and a full certificate report.

The seller may access the Virtual Showroom 5010 to upload photos and descriptions of the vehicle, access marketing support tools such as advertising options, sales suggestions, printable signs, and personalized potential purchaser information cards. The seller may also view information such as warranty information on the vehicle, purchasing information for the vehicle, and loan information.

The potential purchaser may enter the Virtual Showroom 5015 to search for available vehicles and view the certificate reports of vehicles in which she is interested. He may use the Virtual Showroom to contact a loan provider, to obtain information about the vehicle, to purchase a warranty or extended warranty on the vehicle, to obtain insurance information and contact insurance providers, and to contact the seller.

Based on the information in the Virtual Showroom, a potential purchaser may decide whether to pursue purchasing the vehicle 1100.

Should the potential purchaser decide not to purchase a particular vehicle, she may re-enter the Virtual Showroom at any time and continue to search for a suitable vehicle 5020.

Although anyone may enter the Virtual Showroom at any time, the seller is under no obligation to utilize the Virtual Showroom in the marketing of the vehicle.

The seller may also market the vehicle by making use of a provided lawn sign (not shown) placed alongside or on the vehicle to display its certified status to the public.

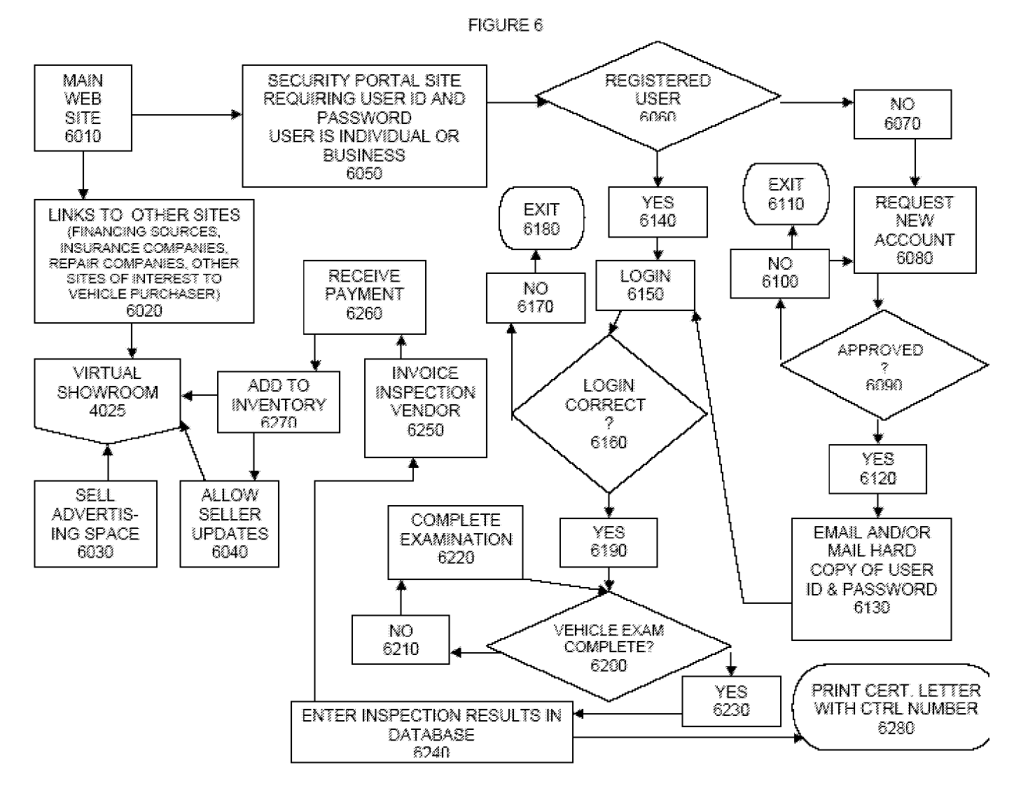

Referring now to FIG. 6, an overview of one embodiment of a secure system behind the online Virtual Showroom is shown. The main website 6010 contains links to other sites 6020 (such as financing sources, insurance companies, repair companies, and other sites that may be of interest to a vehicle purchaser). These sites are linked into the online Virtual Showroom 4025, where the main website's owner may also sell advertising space 6030 as an additional revenue stream, and may allow vehicle sellers to update their individual listings 6040.

The main web site 6010 contains a security portal that requires a unique user ID and password to access the full functionality of the Virtual Showroom 6050. When a user first visits the main site, she is presented with a login screen that asks for a user ID and password 6060. If she is not a registered user 6070, she may request a new account 6080. If approval requirements 6090 are not met 6100, the user may either request a new account 6080 again, or exit the Virtual Showroom's main website 6110. If approval requirements 6090 are met 6120, the system emails and/or mails a hard copy of the user's ID and password to the user 6130.

Once the user receives the ID and password 6130, he can login 6150. The system matches the user ID with the password; if the match is incorrect 6170, the user may attempt to login 6150 again, or he may exit the system 6180. If the match 6160 is correct 6190, the system asks if the vehicle examination is complete 6200. If the examination is not complete 6210, the seller gets the vehicle examined 6220.

Once the examination is complete 6230, the seller enters the examination results into the database 6240. The system then invoices the seller 6250 and receives payment 6260. The vehicle is added to the inventory 6270 and is shown in the Virtual Showroom 4025. Note that the seller may update his listing at any time 6040. The system also prints out a certificate letter with a unique control number 6280 that is used to identify the vehicle in the Virtual Showroom.

Other embodiments of a secure website are also within the scope of the present invention.

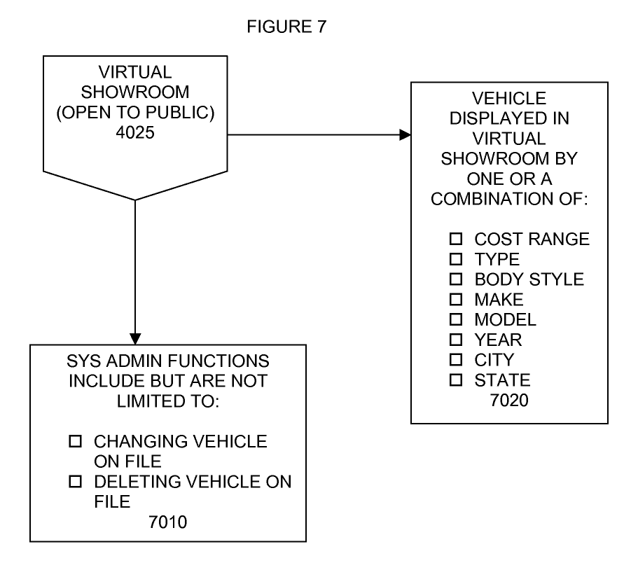

Referring now to FIG. 7, an overview of system administration functions that are available to system administrators (not to a general user) of the online Virtual Showroom is shown. System administrator functions include but are not limited to changing and deleting the vehicle on file 7010. The system can display the vehicles by one or a combination of the following criteria 7020: Cost range; Type; Body style; Make; Model; Year; City; State.

Each of the above-discussed processes may be utilized within the scope of the invention by either an individual person or by a business that needs to sell its used vehicle or vehicles.

The embodiments provided here are examples only and are not intended to be a complete listing of possible embodiments, nor should they be construed as an exclusive listing of embodiments. Variations in the described invention and its uses are possible within the scope of this disclosure without departing from the subject matter coming within the scope of claims to be examined, and a reasonable equivalency thereof, which I regard as my invention.

I claim:

1. A method of vehicle sale by a private seller, said private seller being either an individual or a business selling its used vehicles, comprising:
a seller deciding to sell a vehicle without using the services of a vehicle dealer;
said seller deciding to obtain certification for the vehicle to be sold;
said seller utilizing an external commercially well-known vehicle maintenance-and-repair vendor to perform an evaluation of the condition of the vehicle;
said vendor evaluating said vehicle against pre-set standards;
said vendor issuing a certification to said seller indicating whether said vehicle meets pre-set standards;
said seller advertising the vehicle for sale as a certified pre-owned vehicle;
a potential purchaser responding to said seller's advertisement;
said seller showing said certified pre-owned vehicle to said potential purchaser;
said potential purchaser deciding to purchase said vehicle;
said seller and said potential purchaser agreeing on terms of the sale
said vehicle being sold to said potential purchaser.

2. The method of claim 1 wherein said vehicle is a member of the group consisting of an automobile, a sport utility vehicle, a pickup truck, a van, a recreational vehicle such as a mobile home or camper, a heavy truck, a bus, a boat, a motorized water-ski recreational vehicle, a yacht, a snowmobile, a motorcycle, and a motorized bicycle.

3. The method of claim 1 wherein said pre-set standards comprise any combination of members selected from the group consisting of Headlight assembly, Fog lamp assembly, Headlight washer assembly, Wiper blade, assembly & jets, Door handle, hinge & lock, Central locking functions, Alarm functions, Seat & headrest functions, Seatbelt(s), Airbag(s), Child locking functions, Fuel-filler door locking, Trunk lock, Rear wiper, Shocks, Suspension components, Front control arm brushings, Steering, Major component mounts, Exhaust system, Belts, Belt tensions, Oil fluid level, Brake fluid level, Power steering fluid level, Washer fluid level, Transmission fluid level, Rear axle fluid level, Coolant protection level, Transmission fluid leak, Transfer case fluid leak, Differential fluid leak (right and left), Half shaft fluid leak (right and left), Gas leak, Brake fluid leak, Power steering fluid leak, Shocks and struts fluid leak, Self-leveling fluid leak, Coolant fluid leak, Hydraulic fluid leak, Battery voltage, Front bumper condition, Hood condition, Core support condition, Engine carrying rails condition, Inner fenders condition, Front fenders condition, Pillars A, B, C, D conditions (left and right), Rocker/sill panels condition, Roof condition, Covertible top condition, Sunroof condition, Quarter panel (left and right) condition, Antenna condition, Trunk lid condition, Hatch condition, Tailgate condition, Rear license plate condition, Rear taillight assemblies condition, Rear bumper condition, Spare wheel well condition, Rear floor pan condition, Inner trunk panels condition, Fuel-filler door condition, Mirror assemblies condition, Alignment of all panels, Windshield, VIN ID, Door and side glass, Rear window, Exterior mirror, Interior mirrors, Door weather seal, Carpet or floormat, Wood trim, Cupholders, Interior lights, Glove box, Seat, Headliner, Master keys, Valet keys, Wallet keys, Tires, Driver's seat functions including belt, front/back/up/down, headrest, lumbar, Mirror functions including outside left and right and interior, Navigation system including a functional test, On-board computing system including a functional test, Steering wheel including adjustable, airbag, audio functions, horn functions, Stalk controls including wiper/washer, high beams and computer, Pedal function including gas, brake and clutch, Gear shift function, Parking brake function, HVAC control including heat, air conditioning, fan, temperature range, blower speed, blowers for defrost, center and lower, vent controls, windshield defogger, rear window defrost, re-circulating, Audio function including radio AM and FM, cassette, CD, speakers balance and speakers fade, Electrical system including vanity visor, map/interior light, headlights, fog lights, turn signals, hazard flashers, parking/side markers, brake lights, back-up lights, plate lights, dash and console, door lock, seat heaters, power windows, cigarette lighter, and power sunroof, Engine performance including cold and hot starting, idle smoothness, and acceleration, Transmission shifting including manual and automatic shifting, Cruise control functions, Noise levels including wind, squeaks, rattles, Vehicle handling including vibration, stability, braking, ABS, ASC/DC, Steering wheel alignment, Instrument gauges, and Other functions that the technician may believe necessary to report on.

4. The method of claim 1 wherein a vehicle that does not meet said pre-set standards can still be certified by said seller repairing the components necessary to meet the standards against which said vendor inspected said vehicle.

5. The method of claim 1 wherein a vehicle that does not meet pre-set standards can still be certified by said seller taking an action relating to each component from the group consisting of repairing and replacing the component necessary to meet industry standards.

6. The method of claim 1 wherein said seller fails to repair said vehicle and said certificate discloses all non-repaired items that fail to meet said pre-set standards.

7. The method of claim 1 wherein said certificate provided to said seller by said vendor differentiates between vehicles that meet pre-set standards and those that do not meet pre-set standards.

8. The method of claim 1 wherein said certificate contains information regarding the date of vehicle examination, a vendor-issued unique identifier for each vehicle inspected by said vendor, vehicle details such as: VIN, color, make, model, year, specifications of particular items, repair information, warranty information if applicable, and any repairs needed that were discovered in said vehicle examination and said repair was declined by said seller.

9. The method of claim 1 wherein said seller utilizes an optional, proprietary Virtual Showroom to advertise said vehicle.

10. The method of claim 1 wherein said seller advertises said vehicle using marketing methods comprising: classified or display newspaper advertisements, publications such as a classified advertising digest that list items for sale, and a for-sale sign in the window of the vehicle.

11. The method of claim 1 wherein said seller markets said vehicle using print and web-based advertising simultaneously 4010.

12. The method of claim 1 wherein said seller markets said vehicle without web-based advertising.

13. The method of claim 1 wherein said seller advertises said vehicle with any vehicle sales internet site that is not affiliated with said Virtual Showroom.

14. The method of claim 9 wherein said seller uses said Virtual Showroom service exclusively or in combination with standard marketing methods.

15. The method of claim 9 wherein said Virtual Showroom contains details of said vehicle examination by said vendor, including an electronic version of said certificate, details about said vehicle, and a full certificate report.

16. The method of claim 9 wherein said seller may access said Virtual Showroom to upload photos and descriptions of the vehicle, access marketing support tools such as advertising options, sales suggestions, printable signs, personalized potential purchaser information cards, and may also view information such as warranty information on said vehicle, purchasing information for said vehicle, and loan information.

17. The method of claim 9 wherein said potential purchaser may enter said Virtual Showroom to search for available vehicles and view certificate reports of vehicles, to contact a loan provider, to obtain information about said vehicle, to purchase a warranty or extended warranty on said vehicle, to obtain insurance information, to contact insurance providers, and to contact said seller.

18. A method of vehicle sale by a private seller, said private seller being either a private individual or a business, comprising:
a seller deciding to sell a vehicle without using the services of a vehicle dealer;
said seller deciding to obtain certification for the vehicle to be sold;
said seller utilizing an external commercially well-known vehicle maintenance-and-repair vendor to perform an evaluation of the condition of the vehicle;
said vendor evaluating said vehicle against pre-set standards;
said vendor issuing a certificate to a vehicle indicating whether said vehicle meets pre-set standards;
said seller advertising the vehicle for sale as a certified pre-owned vehicle utilizing a Virtual Showroom, said Virtual Showroom providing said seller with the ability to upload photos and descriptions of the vehicle, access marketing support tools such as advertising options, sales suggestions, printable signs, personalized potential purchaser information cards, and may also view information such as warranty information on said vehicle, purchasing information for said vehicle, and loan information, and providing a potential purchaser with the ability to search for available vehicles and view certificate reports of vehicles, to contact a loan provider, to obtain information about said vehicle, to purchase a warranty or extended warranty on said vehicle, to obtain insurance information, to contact insurance providers, and to contact said seller, and said Virtual Showroom containing details of said vehicle examination by said vendor, including an electronic version of said certificate, details about said vehicle, and a full certificate report;
said potential purchaser responding to said seller's advertisement;
said seller showing said certified pre-owned vehicle to said potential purchaser;
said potential purchaser deciding to purchase said vehicle;
said seller and said potential purchaser agreeing on terms of the sale
said vehicle being sold to said potential purchaser.

19. The method of claim 18 wherein said vehicle is a member of the group consisting of an automobile, a sport utility vehicle, a pickup truck, a van, a recreational vehicle such as a mobile home or camper, a heavy truck, a bus, a boat, a motorized water-ski recreational vehicle, a yacht, a snowmobile, a motorcycle, and a motorized bicycle.

20. The method of claim 18 wherein a vehicle that does not meet said pre-set standards can still be certified by said seller repairing, replacing, or both the components necessary to meet the standards against which said vendor inspected said vehicle, said pre-set standards comprising any combination of members of the group consisting of Headlight assembly, Fog lamp assembly, Headlight washer assembly, Wiper blade, assembly & jets, Door handle, hinge & lock, Central locking functions, Alarm functions, Seat & headrest functions, Seatbelt(s), Airbag(s), Child locking functions, Fuel-filler door locking, Trunk lock, Rear wiper, Shocks, Suspension components, Front control arm brushings, Steering, Major component mounts, Exhaust system, Belts, Belt tensions, Oil fluid level, Brake fluid level, Power steering fluid level, Washer fluid level, Transmission fluid level, Rear axle fluid level, Coolant protection level, Transmission fluid leak, Transfer case fluid leak, Differential fluid leak (right and left), Half shaft fluid leak (right and left), Gas leak, Brake fluid leak, Power steering fluid leak, Shocks and struts fluid leak, Self-leveling fluid leak, Coolant fluid leak, Hydraulic fluid leak, Battery voltage, Front bumper condition, Hood condition, Core support condition, Engine carrying rails condition, Inner fenders condition, Front fenders condition, Pillars A, B, C, D conditions (left and right), Rocker/sill panels condition, Roof condition, Covertible top condition, Sunroof condition, Quarter panel (left and right) condition, Antenna condition, Trunk lid condition, Hatch condition, Tailgate condition, Rear license plate condition, Rear taillight assemblies condition, Rear bumper condition, Spare wheel well condition, Rear floor pan condition, Inner trunk panels condition, Fuel-filler door condition, Mirror assemblies condition, Alignment of all panels, Windshield, VIN ID, Door and side glass, Rear window, Exterior mirror, Interior mirrors, Door weather seal, Carpet or floormat, Wood trim, Cupholders, Interior lights, Glove box, Seat, Headliner, Master keys, Valet keys, Wallet keys, Tires, Driver's seat functions including belt, front/back/up/down, headrest, lumbar, Mirror functions including outside left and right and interior, Navigation system including a functional test, On-board computing system including a functional test, Steering wheel including adjustable, airbag, audio functions, horn functions, Stalk controls including wiper/washer, high beams and computer, Pedal function including gas, brake and clutch, Gear shift function, Parking brake function, HVAC control including heat, air conditioning, fan, temperature range, blower speed, blowers for defrost, center and lower, vent controls, windshield defogger, rear window defrost, re-circulating, Audio function including radio AM and FM, cassette, CD, speakers balance and speakers fade, Electrical system including vanity visor, map/interior light, headlights, fog lights, turn signals, hazard flashers, parking/side markers, brake lights, back-up lights, plate lights, dash and console, door lock, seat heaters, power windows, cigarette lighter, and power sunroof, Engine performance including cold and hot starting, idle smoothness, and acceleration, Transmission shifting including manual and automatic shifting, Cruise control functions, Noise levels including wind, squeaks, rattles, Vehicle handling including vibration, stability, braking, ABS, ASC/DC, Steering wheel alignment, Instrument gauges, and Other functions that the technician may believe necessary to report on.

21. The method of claim 18 wherein said seller fails to repair said vehicle and said certificate shows all non-repaired items that caused the vehicle to not meet said pre-set standards.

22. The method of claim 18 wherein said certificate provided to said seller by said vendor differentiates between vehicles that meet pre-set standards and those that do not meet pre-set standards.

23. The method of claim 18 wherein said certificate contains information regarding the date of vehicle examination, a vendor-issued unique identifier for each vehicle inspected by said vendor, vehicle details such as: VIN, color, make, model, year, specifications of particular items, repair information, warranty information if applicable, and any repairs needed that were discovered in said vehicle examination and said repair was declined by said seller.

24. A method of vehicle sale by a private seller, said private seller being either an individual or a business, comprising:
a seller deciding to sell a vehicle without using the services of a vehicle dealer;
said seller deciding to obtain certification for the vehicle to be sold;
said seller utilizing an external commercially well-known vehicle maintenance-and-repair vendor to perform an evaluation of the condition of the vehicle;
said vendor evaluating said vehicle against pre-set standards, said pre-set standards comprising any combination of members of the group consisting of Headlight assembly, Fog lamp assembly, Headlight washer assembly, Wiper blade, assembly & jets, Door handle, hinge & lock, Central locking functions, Alarm functions, Seat & headrest functions, Seatbelt(s), Airbag(s), Child locking functions, Fuel-filler door locking, Trunk lock, Rear wiper, Shocks, Suspension components, Front control arm brushings, Steering, Major component mounts, Exhaust system, Belts, Belt tensions, Oil fluid level, Brake fluid level, Power steering fluid level, Washer fluid level, Transmission fluid level, Rear axle fluid level, Coolant protection level, Transmission fluid leak, Transfer case fluid leak, Differential fluid leak (right and left), Half shaft fluid leak (right and left), Gas leak, Brake fluid leak, Power steering fluid leak, Shocks and struts fluid leak, Self-leveling fluid leak, Coolant fluid leak, Hydraulic fluid leak, Battery voltage, Front bumper condition, Hood condition, Core support condition, Engine carrying rails condition, Inner fenders condition, Front fenders condition, Pillars A, B, C, D conditions (left and right), Rocker/sill panels condition, Roof condition, Covertible top condition, Sunroof condition, Quarter panel (left and right) condition, Antenna condition, Trunk lid condition, Hatch condition, Tailgate condition, Rear license plate condition, Rear taillight assemblies condition, Rear bumper condition, Spare wheel well condition, Rear floor pan condition, Inner trunk panels condition, Fuel-filler door condition, Mirror assemblies condition, Alignment of all panels, Windshield, VIN ID, Door and side glass, Rear window, Exterior mirror, Interior mirrors, Door weather seal, Carpet or floormat, Wood trim, Cupholders, Interior lights, Glove box, Seat, Headliner, Master keys, Valet keys, Wallet keys, Tires, Driver's seat functions including belt, front/back/up/down, headrest, lumbar, Mirror functions including outside left and right and interior, Navigation system including a functional test, On-board computing system including a functional test, Steering wheel including adjustable, airbag, audio functions, horn functions, Stalk controls including wiper/washer, high beams and computer, Pedal function including gas, brake and clutch, Gear shift function, Parking brake function, HVAC control including heat, air conditioning, fan, temperature range, blower speed, blowers for defrost, center and lower, vent controls, windshield defogger, rear window defrost, re-circulating, Audio function including radio AM and FM, cassette, CD, speakers balance and speakers fade, Electrical system including vanity visor, map/interior light, headlights, fog lights, turn signals, hazard flashers, parking/side markers, brake lights, back-up lights, plate lights, dash and console, door lock, seat heaters, power windows, cigarette lighter, and power sunroof, Engine performance including cold and hot starting, idle smoothness, and acceleration, Transmission shifting including manual and automatic shifting, Cruise control functions, Noise levels including wind, squeaks, rattles, Vehicle handling including vibration, stability, braking, ABS, ASC/DC, Steering wheel alignment, Instrument gauges, and Other functions that the technician may believe necessary to report on;
said vendor issuing a certificate that differentiates between a vehicle that meets said set of pre-set standards and a vehicle that does not meet pre-set standards and shows all needed repairs to a vehicle and that contains information regarding the date of vehicle examination, a vendor-issued unique identifier for each vehicle inspected by said vendor, vehicle details such as: VIN, color, make, model, year, specifications of particular items, repair information, warranty information if applicable, and any repairs needed that were discovered in said vehicle examination and said repair was declined by said seller;
said seller advertising the vehicle for sale as a certified pre-owned vehicle utilizing a Virtual Showroom, said Virtual Showroom providing said seller with the ability to upload photos and descriptions of the vehicle, access marketing support tools such as advertising options, sales suggestions, printable signs, personalized potential purchaser information cards, and may also view information such as warranty information on said vehicle, purchasing information for said vehicle, and loan information, and providing a potential purchaser with the ability to search for available vehicles and view certificate reports of vehicles, to contact a loan provider, to obtain information about said vehicle, to purchase a warranty or extended warranty on said vehicle, to obtain insurance information, to contact insurance providers, and to contact said seller, and said Virtual Showroom containing details of said vehicle examination by said vendor, including an electronic version of said certificate, details about said vehicle, and a full certificate report;
said potential purchaser responding to said seller's advertisement;
said seller showing said certified pre-owned vehicle to said potential purchaser;
said potential purchaser deciding to purchase said vehicle;
said seller and said potential purchaser agreeing on terms of the sale
said vehicle being sold to said potential purchaser.

25. The method of claim 24 wherein said vehicle is a member of the group consisting of an automobile, a sport utility vehicle, a pickup truck, a van, a recreational vehicle such as a mobile home or camper, a heavy truck, a bus, a boat, a motorized water-ski recreational vehicle, a yacht, a snowmobile, a motorcycle, and a motorized bicycle.

26. The method of claim 24 wherein a vehicle that does not meet said set of pre-set standards can still be certified by said seller repairing, replacing, or both the components necessary to meet the standards against which said vendor inspected said vehicle.
